(19) United States
(12) Patent Application Publication
(10) Pub. No.: US 2024/0231420 A1
(43) Pub. Date: Jul. 11, 2024

(54) SYSTEMS, METHODS AND COMPUTER READABLE MEDIUM FOR VISUAL SOFTWARE DEVELOPMENT QUALITY ASSURANCE

(71) Applicant: Engineer.ai Naya Limited, Los Angeles, CA (US)

(72) Inventors: Marco Quaglio, London (GB); Siddhartha Ghosh, London (GB); Sachin Dev Duggal, London (GB); Rohan Patel, London (GB); Joseph Rifkin, Los Angeles, CA (US)

(21) Appl. No.: 18/440,299

(22) Filed: Feb. 13, 2024

Related U.S. Application Data
(63) Continuation of application No. 17/349,807, filed on Jun. 16, 2021, now abandoned.
(60) Provisional application No. 63/039,064, filed on Jun. 15, 2020.

(51) Int. Cl. G06F 1/16; A47B 97/00; G06F 11/36; G06F 18/22; G06T 7/00

(52) U.S. Cl. CPC G06F 1/1601; A47B 97/00; G06F 11/366; G06F 18/22; G06T 7/001; G06T 2200/24; G06T 2207/30168

(57) ABSTRACT

A computer-implemented method for identifying discrepancies between a design image of a user interface for an application and a screenshot of the user interface as displayed by the application includes performing a first comparison between the design image and the screenshot to identify one or more discrepancies between the images, excluding from the discrepancies those corresponding to visual elements on the screenshot that include dynamic content, and generating an image of the screenshot, wherein the image includes a visual indication of every discrepancy detected by the second comparison as the identified discrepancies between the design image and the screenshot.

This application is a continuation of U.S. patent application Ser. No. 17/349,807, filed on Jun. 16, 2021, which claims the benefit of U.S. Provisional Patent Application No. 63/039,964, filed on Jun. 16, 2020, each of which is incorporated herein in their entirety.

### FIELD OF THE INVENTION

Embodiments of the present invention are directed to software development. Specifically, embodiments of the present invention are directed to systems and methods for providing visual quality assurance of software applications under development.

### BACKGROUND

User Interface (UI) layout and functionality is an important aspect of software development. The software development process can include a step in which one or more display screens are generated on a device to provide a graphical visual interface. These are generated using executable code to provide the front end (whether static or dynamic). The visual elements of the display screen generated by the software executable can be graphical elements generated for example by a software module. The visual elements can be images that are retrieved for an image file. Other visual elements can be fonts, colors, icons, menu structures, buttons, etc. The software development process is, in a standard way for development, structured where a designer generates visual images (e.g., static images) such as in an image file as the visual design that the executable software is to deliver when the software is developed and running. A good UI facilitates the use and enjoyment of an application can be dispositive of its success. Significant resources are poured into optimal UI design that effectively combine aesthetics and functionality. To ensure that the design is rendered correctly by the application, quality assurance processes are used to compare the design with the UI as rendered by the software.

Quality Assurance (QA) for User Interfaces represents an important step in the software development cycle. The process involves the comparison of original designs (i.e. what the designer and the customer agreed on), with the respective UIs (i.e. what the developer implemented in the front-end and ultimately appears on the screen of a computing device). The QA process is primarily carried out by patient and meticulous QA testers. Needless to say, it can be tedious. Indeed, visual quality check of the output of the software development process can be time consuming, difficult, and imprecise. In addition, the QA process for designs is sensitive to human judgement and the outcomes can vary from individual to another. Further, the software application often times is developed for multiple platforms, devices, screen sizes for resolution), or operating environments. For example, one starting display screen (or portion thereof) may have many corresponding application implementations (e.g., IOS, Android, Windows, etc.). Known QA processes are not capable of assisting in software development with tools that address such complex situations or provide related features.

Systems and methods have been proposed to automate or otherwise facilitate the QA process for UIs. In particular, systems exist that implements the ability to automatically compare the original design of a UI with the actual UI as displayed by an application in order to identify and correct deficiencies in the application's rendering. However, such systems present several deficiencies. For example, existing systems are unable to detect dynamic content in their analyses of UIs. This inability to account for parts of the screen that change (e.g., animation, widgets, etc) generates false positives during automatic comparisons between designs and displayed UIs

What is desired is a system and method for providing quality assurance of UIs that is more accurate than a human tester and can operate at a pixel level. It is also desired to provide a system and method that can detect and account for dynamic content on the screen and minimize the generation of false positives.

### SUMMARY OF THE INVENTION

Embodiment of the present invention disclose a quality assurance system for visual software development. The quality assurance system includes a quality assurance application implemented on a computer using computer readable software instructions stored in non-transient memory, and configured for identifying discrepancies between a design image of a user interface for an application and a screenshot of the user interface as displayed by the application, wherein the quality assurance application is further configured to perform computer-implemented steps including: performing a first comparison between the design image and the screenshot to identify one or more discrepancies between the images; excluding from the discrepancies those corresponding to visual elements on the screenshot that include dynamic content, the excluding including: identifying which of the discrepancies are structural discrepancies; applying a mask to every visual element corresponding to a structural discrepancy on both the design image and the screenshot, wherein the mask is shaped like the visual element; performing a second comparison between the masked design image and masked screenshot, wherein a lack of discrepancies detected by the second comparison between a masked visual element on the design image and the corresponding masked visual element on the screenshot indicates that the visual element on the screenshot includes dynamic content; and generating an image of the screenshot, wherein the image includes a visual indication of every discrepancy detected by the second comparison as the identified discrepancies between the design image and the screenshot.

In some embodiments, the steps further include generating and displaying a discrepancy map showing areas of discrepancy between the design image and the screenshot as shaded areas.

In some embodiments, performing the first or the second comparison includes traversing the design image and the screenshot using an SSIM analysis on every pixel.

In some embodiments, the one or more discrepancies include color patches, missing elements, and structural discrepancies. In some of these embodiments, each of color patches, missing elements, and structural discrepancies is identified based on different combinations of local luminance similarity, local contrast similarity, and local structure similarity

In some embodiments, applying the mask includes applying a contrast-based mask than applies a shadow to regions of the visual element corresponding to the structural discrepancy where contrast is higher than a small value.

In some embodiments, the system further includes generating a bug report that includes an inventory of the identified discrepancies, their location, and measures of the divergence of their corresponding visual elements from the design image.

Embodiments of the present invention also disclose a computer-implemented method for identifying discrepancies between a design image of a user interface for an application and a screenshot of the user interface as displayed by the application. The method includes performing a first comparison between the design image and the screenshot to identify one or more discrepancies between the images; excluding from the discrepancies those corresponding to visual elements on the screenshot that include dynamic content, the excluding including: identifying which of the discrepancies are structural discrepancies; applying a mask to every visual element corresponding to a structural discrepancy on both the design image and the screenshot, wherein the mask is shaped like the visual element; performing a second comparison between the masked design image and masked screenshot, wherein a lack of discrepancies detected by the second comparison between a masked visual element on the design image and the corresponding masked visual element on the screenshot indicates that the visual element on the screenshot includes dynamic content, and generating an image of the screenshot, wherein the image includes a visual indication of every discrepancy detected by the second comparison as the identified discrepancies between the design image and the screenshot.

In some embodiments, the method further includes generating and displaying a discrepancy map showing areas of discrepancy between the design image and the screenshot as shaded areas.

In some embodiments, performing the first or the second comparison includes traversing the design image and the screenshot using an SSIM analysis on every pixel.

In some embodiments, the one or more discrepancies include color patches, missing elements, and structural discrepancies. In some of these embodiments, each of color patches, missing elements, and structural discrepancies is identified based on different combinations of local luminance similarity, local contrast similarity, and local structure similarity.

In some embodiments, applying the mask includes applying a contrast-based mask than applies a shadow to regions of the visual element corresponding to the structural discrepancy where contrast is higher than a small value.

In some embodiments, the method further includes generating a bug report that includes an inventory of the identified discrepancies, their location, and measures of the divergence of their corresponding visual elements from the design image.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1 illustrates a system for providing visual quality control of user interfaces according to an embodiment of the present invention.

FIG. 2 illustrates a block diagram of an exemplary system for automatically detecting and identifying discrepancies in a user interface of a software application, according to an embodiment of the present invention.

FIG. 3 illustrates a visual interface of the system of an embodiment of the present invention.

FIG. 4 illustrates a discrepancy map as a combination of a structure map, contrast map, and luminance map according to an embodiment of the present invention.

FIG. 5A illustrates a design-UI pair of images featuring dynamic content 580 according to an embodiment of the present invention.

FIG. 5B illustrates the masked out design-UI pair according to an embodiment of the present invention.

FIG. 5C illustrates close ups of visual element on each of the design and screenshot images, before and after masking, according to an embodiment of the present invention.

FIG. 5D illustrates before and after masking details of element on each of the design and UI images, according to an embodiment of the present invention.

FIG. 6 illustrates a graph visualization of a test or an assessment of UI rendering.

Certain examples and embodiments have other features that are one of in addition to and in lieu of the features illustrated in the above-referenced figures. These and other features are detailed below with reference to the above-referenced figures.

### DETAILED DESCRIPTION OF THE INVENTION

Embodiments of the present invention, provide for a software development application that receives and loads an image that is a designer's illustration of a display screen (or a portion thereof), which may have been entirely or partially manually prepared by an illustrator on an illustration software application, and receives and loads a corresponding display screen that is generated by the software application under development (in which the designer illustrated images are a specified component of the design for the software application under development).

The display screen can be a screen shot (screen capture) or image generated (e.g., automatically generated) from the software generated display screen. The software development application applies an algorithm in which the software development application traverses the contents of the image of the designer illustration image and the contents of the display screen (e.g., in image capture form). The traversal can sequential, simultaneously, or some combination thereof. One or more algorithms can be applied as part of the traversal that identifies the discrepancies between the illustrated image and the software generated display screen. One or more algorithms can be applied to identify discrepancies as qualifying as bugs for reporting to the software development team. One or more algorithms can be applied that automatically based on the received and identified discrepancies provide an adjustment to the software implementation of the display screen to remove or reduce the discrepancy.

A visual interface can be generated that provides a visual illustration of the discrepancies which can be generated using different parameters from the algorithm. The visual interface of generated image can provide intuitive tools for a software developer, design illustrator, or a client to understand and in response, decide to take action (or automated action based on the output can be applied to the code).

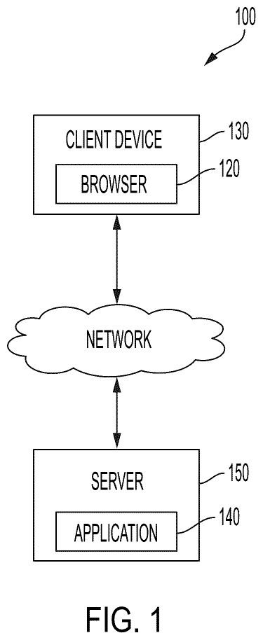

FIG. 1 illustrates a system 100 for providing visual quality control of user interfaces according to an embodiment of the present invention. The system includes a software application 120 installed on an electronic device 130 and quality control application 140 implemented on a server 150. The electronic device 130 is preferably a desktop computer that can communicate with server via mobile networks or other wireless networks. Each of the electronic device and servers is a computer system that includes a microprocessor and volatile and non-volatile memory to configure the computer system. The computer system 130 also includes a network connection interface that allows the computer system 130 to communicate with another computer system over a network. Each software application may also be used independently or in conjunction with another software application to strengthen or supplement functionalities of the other software application.

The quality control application 140 is configured to provide a visual interface that enables a customer to interact with the system. In some embodiments, the quality control application is a web application provided by the server and configured to run in a conventional browser 120. The visual interface may thus be displayed in a conventional browser 120 on the client computing device 130.

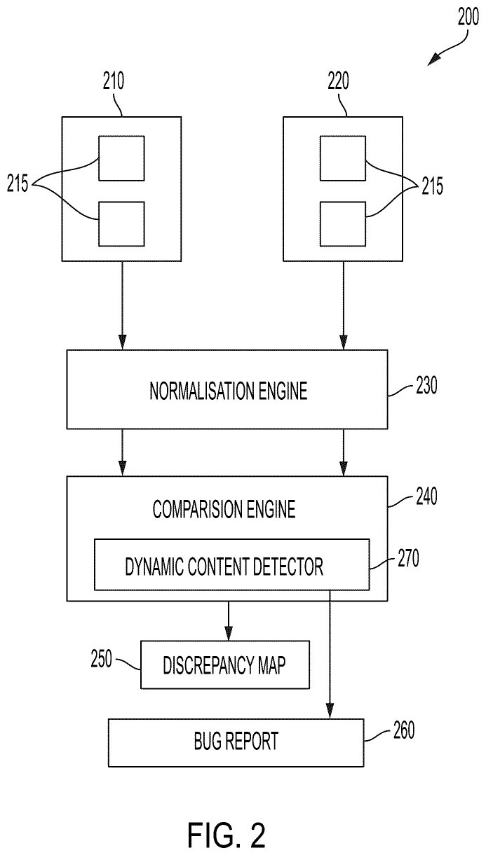

FIG. 2 illustrates an example block diagram of a system 200 for automatically detecting and identifying discrepancies in a user interface of a software application, according to an embodiment of the present invention. The system 200 receives as inputs a pair of images, a first image 210 representing the original design of a user interface, and a second image 220 being an image of the actual user interface, that is the application's render of the original design 210 of the user interface. The original design image 210 or reference image 210 is the image of the user interface as conceived before or during the development of the application by graphic artists or developers, and is the model for the user interface rendered by the application. The design image 210 includes one or more visual elements 215. The reference image 210 may be generated through a variety of means, such as a graphic design application, a CAD application, or any other means of generating a picture of the intended design. The user interface image 220 or application render 220 is preferably a screenshot of the application. The user interface 220 may also otherwise have been generated or rendered by the application, provided that it is an exact representation of the user interface 220 as displayed on the screen. Each of original design image 210 or reference image 210 and the actual application's image or screenshot 220 can be in a variety of image file formats. These include Windows Bitmap (bmp), Portable Image Formats (pbm, pgm, ppm), Sun Raster (sr, ras), JPEG (jpeg, jpg, jpe), JPEG 2000 (jp2), TIFF files (tiff, tif), Portable Network Graphics (png), among others.

The pair of images 210, 220 is first received and processed by a normalization engine 230. The normalization engine 230 is configured to format or convert the images 210, 220 into a format that enables comparison. For example, the normalization engine 230 compares the pixel dimensions of the original design image 210 and the screenshot 220. If the dimensions are not identical, the screenshot 220 is resized to match the dimensions of the original design image 210. The normalization engine 230 may also change the format of an image to match the other or of both images to match to match the preferred image format of the normalization engine 230. In some embodiments, images are converted into PNG format. The converted design image 210 and the screenshot 220 are then sent to the comparison engine 240.

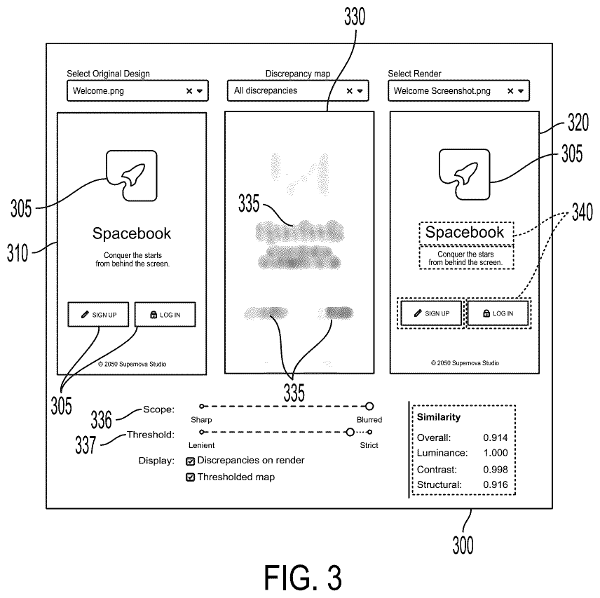

The comparison engine 240 is first configured to locate and detect discrepancies between the received image and the application screenshot 220. To that end, the comparison engine 240 compares the received design image 210 and screenshot 220 to generate a discrepancy map 250. FIG. 3 illustrates a visual interface 300 of the system of the present invention. The visual interface 300 provided by the application enables the user to interact with the system. In some embodiments, the application my run on a server as a web app, and the visual interface of the application may be displayed in a conventional browser on a client computing device (see FIG. 1). The visual interface 300 displays the intended design image 310 and the application screenshot 320 both previously uploaded to the system as described above. Each of the images 310 and 320 exhibits visual elements 305. The visual interface further displays a discrepancy map 330.

The discrepancy map 330 is an image that shows the result comparison between the two images 310, 320. In particular, the discrepancy map 320 shows locations 335 where the comparison engine has detected some difference between the design image 310 and the corresponding screenshot 320 of the application in development. Thus, the parts of the images that are identical are blank on the map, and the parts where differences exist between the reference image 310 and the actual user interface 320 are shaded 335. The darkness of the shading 335 in any one location reflects the severity of the discrepancy at that location.

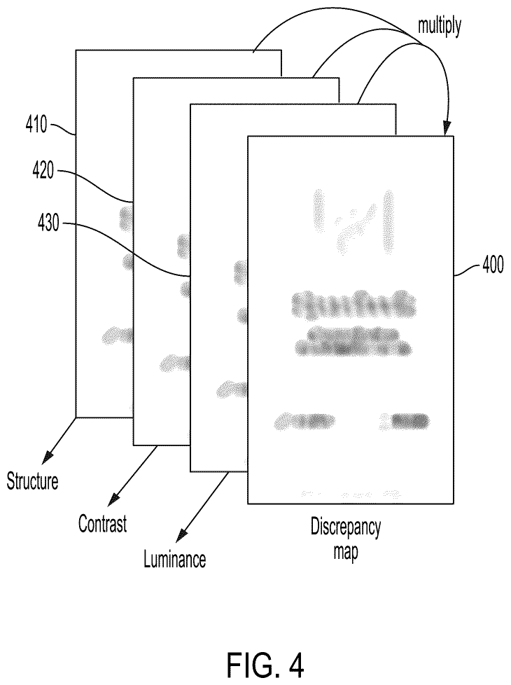

The comparison engine may generate the discrepancy map 330 using a variety of image comparison techniques. In one embodiment, the discrepancy map is generated by performing a pixel-wise comparison between original image and the UI image. Specifically, the comparison engine traverse the content of the images 310, 320 using a Structural Similarity Index Method (SSIM) algorithm on every pixel of the images to obtain the discrepancy map 330. SSIM a statistical method to comprehensively evaluate differences between images and is described in Wang, Zhou & Bovik, Alan & Sheikh, Hamid & Simoncelli, Eero. (2004). Image Quality Assessment: From Error Visibility to Structural Similarity. Image Processing, IEEE Transactions on. 13. 600-612. 10.1109/TIP.2003.819861, which is incorporated herein by reference in its entirety. In this embodiment, the method as implemented employs a sliding window over the entire frame to calculate a local SSIM for each pixel. The SSIM analysis yields three measures of local similarity for each pixel luminance similarity, contrast similarity, and structure similarity. Each pixel similarity measure can serve as a basis for a map, and the luminance map, contrast map, and structure map can be generated. In some embodiments, the user may select to display each of the maps. The combination or superimposition of all three maps yields the discrepancy map. In other words, the discrepancy is made of pixels each having three dimensions or similarity measure: luminance, contrast, and structure. FIG. 4 illustrates a discrepancy map 400 as a combination of a structure map 410, contrast map 420, and luminance map 430.

Referring back to FIG. 3, in some embodiments, user-controlled parameters are provided that affect the detection and mapping of discrepancies 335. For example, the scope parameter 336 determines the resolution of the detector: a sharp scope should be used to highlight discrepancies in small elements in the design-UI pair, such as characters, small icons. A blurred scope may be employed to highlight discrepancies in big elements in the design-UI pair, such as entire words and paragraphs, logos, buttons, images, etc. Threshold value 337 for the map is another parameter that may be provided to the user. The threshold value determines the level of similarity between the design image and the screenshot that will be flagged by the comparison engine as a discrepancy. Threshold thus varies between lenient and strict. Slides or other control means are provided on the user interface to enable the user to change each parameter.

The system uses combinations of the measures of local similarity to identify three different types of discrepancies from the discrepancy map. A first type of discrepancy is color patches, which are identified by areas of extreme structure similarity but low luminance or contrast similarity. Missing or spurious elements constitute a second type of discrepancy, which is indicated by high contrast. Any other discrepancies that do not fall satisfy the color patch or missing/spurious element criteria tend to indicate generic structural or geometrical discrepancies, which indicate discrepancies in the location and size of the visual elements of user interfaces.

The comparison engine is configured to compile the location and type of discrepancies between the original image and the application image into a bug report 260 (see FIG. 2). The bug report 260 provides an inventory of every visual element from the original design that has changed or differs from the intended design. The location of each visual element may be recorded using any of a number of location or coordinate systems that are known in the art of image processing and analysis. Further, the bugs or visual elements that differ from the design image are visually identified on the application screenshot. In the embodiment illustrated in FIG. 3, visual elements that differ from the those of the design image are surrounded with boxes 340.

Referring back to FIG. 2, a dynamic content detector 270 next processes the images in order to account for the dynamic elements in the user interface. Dynamic content may be a combination of text/images that are dynamically generated by some backend process and cannot be expected to match pixel by pixel the text and artworks used by the designer. Unlike static visual element, dynamic elements or dynamic content can generate false positive in the comparison engine because the dynamic visual element on a screenshot of the actual UI is likely to differ from the static picture of the original design. For example, a dynamic visual element such as an animation becomes a static picture on a screenshot having a different visual configuration than the original visual element on the design image. This discrepancy would generate an erroneous bug report about the visual element by the comparison engine without the specialized dynamic content process of the present invention. The dynamic content detector 270 serves to identify the dynamic visual elements of the user interface.

Dynamic content detection is only applied to the visual elements that have been identified as structural or geometrical discrepancies. The dynamic content detector 270 is applied to such elements to determine whether the dynamic content has caused the mismatch. In particular, the dynamic content detector 270 applies a mask or filter to cover all structural discrepancy elements in the area under diagnosis (i.e., where the suspected mismatch between the original image and the screenshot occurred). Effectively, this filter replaces the suspect elements in both the original design image and the screenshot with dark patches broadly having the shapes of the elements under review. In particular, the mask applies a shadow to regions of the bug or discrepancy where contrast is higher than a small positive value, which are detected as elements. Areas of where no contrast is detected are considered background. The dark patches enable the comparison engine 240 to focus on location and shape/size of the structural discrepancy elements rather than the specific text/image content associated with the element. If the comparison engine 240 does not detect any discrepancy in the area under review after the elements under review are masked, the comparison engine 240 will assume the design-screenshot difference is associated with dynamic content and will not be raised as bug to the user.

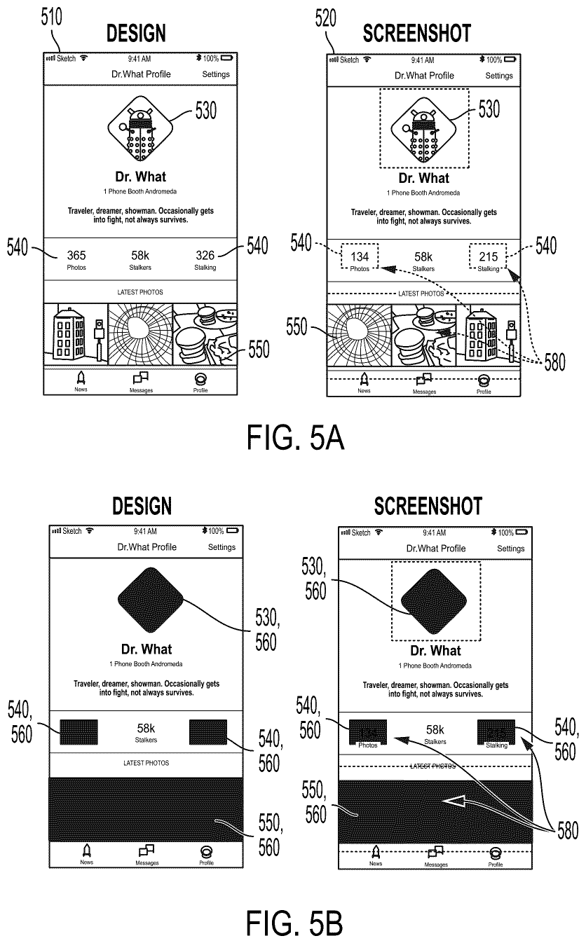

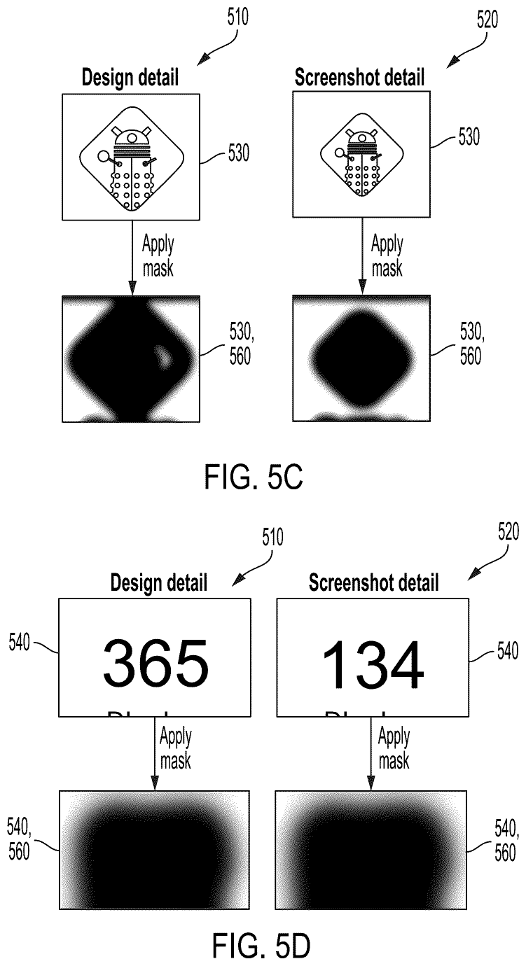

FIG. 5A illustrates a design-UI pair of images 510, 520 featuring dynamic content 580. Visual element 530, 540, and 550 differ between the images. Static element 530 is smaller in the screenshot 510 than in the design image 520 and therefore will trigger a bug report when processed by the comparison engine according to the steps described above. Similarly, elements 540 are flagged by the comparison engine because they differ between the images as they represent different numbers. In additional, elements 550 also trigger the comparison engine because the content of the image windows 550 has varied between the design image 510 and the actual user interface 520.

Next, the dynamic content detector applies a mask to each of the elements flagged by the comparison engine as discrepancies on both images. FIG. 5B illustrates the masked out design-UI pair 510, 520 according to an embodiment of the present invention. Each mask 560 is shaped like the element and comprises a shadow or black pixels. Figure SC illustrates close ups of visual element 530 on each of the design and screenshot images, before and after masking (i.e., covered with mask 560 in the bottom images). Figure SD similarly illustrates before and after masking details of element 540 on each of the design and UI images. As illustrated, the masks 560 approximate the shapes of the elements and cover them completely.

After masks 560 are applied to both images, the comparison engine processes the masked-out images anew to detect discrepancies. The masked out images are traversed pixel-wise according to the process described above and the visual element exhibiting discrepancies are recorded. If any visual element previously detected on the initial pair of design-UL images (before the masking) is still flagged as a discrepancy by the comparison engine after being masked, that element is identified as a real bug in the actual UI. This is because any element flagged after masking exhibit geometric or structural discrepancies that are reflected in the masks. In other words, the size, shape, orientation, or location of the mask for that element differ between the design image and the rendered image, indicating a structural discrepancy independent of any dynamic content. This is the case for element 530 illustrated in FIG. 5C, where the masked element 530, 560 is smaller in the masked screenshot than in the masked design image. In contrast, elements that were previously detected as discrepancies on the first pass through the comparison engine but that the second round after masking did not flag are identified as dynamic content. This is the case for elements 540 illustrated in FIG. 5D, where the masked element 540, 560 retains the same structure (size, shape, etc.) on both the design image and the screenshot image. Dynamic content such as visual element 540 as confirmed by the comparison engine is excluded from further analysis. Though not described in reference to element 550, the same process described above would yield the exclusion of that element as dynamic content as well due to the changing photos exhibited by the screenshot compared to the design image.

After the identifying and excluding dynamic interface elements (e.g., 540), the system can proceed to the full analysis or diagnostic of the remaining discrepancies. The full analysis stage provides additional information to the user regarding visual elements that exhibit differences from the design image. For example, the full analysis can reveal three types of geometrical discrepancies or measures of divergence between design and UI can be identified from the discrepancy map using the combination of similarity measures described above: element shift (visual elements misplaced by a few pixels), element dimensions (when the size of an element is wrong), and element mass (an expression of discrepancy in the element's pixel count). The discrepancy detection, location, and analysis provided by the discrepancy comparison engine of the present invention provides an unprecedented level of precision in evaluating UI interface errors. In particular, the comparison engine measures and record divergences of each element that differs between the original and image and the application UI image down to the pixel. The detailed discrepancy information can be compiled in the bug report, which can be provided to the application development team responsible for the application to enable adjustments thereof.

In some embodiments, the user may select an element identified as exhibiting a discrepancy and in response the visual interface of the application may display measures of the divergences of the element from the source image (e.g., shift, dimensions, pixel count). For example, the application may indicate that an icon or a bloc of text is shifted 150 pixels to the left of its position on the design image and that is 27% smaller than the equivalent element on the design image. The application may enable the user to manually correct the divergence or discrepancy by selecting and manipulating the element (moving, enlargement, etc.) on the screenshot.

In some embodiments, one or more algorithms can be applied that automatically based on the received and identified discrepancies provide an adjustment to the software implementation of the display screen to remove or reduce the discrepancy. The visual interface of generated image can provide intuitive tools for a software developer, design illustrator, or a client to understand and in response, decide to take action (or automated action based on the output can be applied to the code).

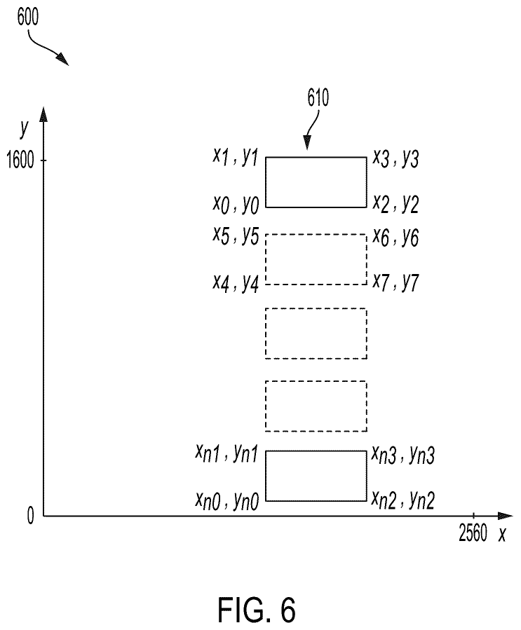

Embodiments of the present invention further disclose methods of measuring aspect of visual performance of UI (such as page load and UI rendering times) as perceived by an end user. FIG. 6 illustrates a graph visualization 600 of a test or an assessment of UI rendering. The test includes providing a visual element 610 or an object containing text on the UI (such as an information bubble), and causing the object to move across the screen and assessing generally whether the object behaves as intended, and in particular whether the motion of the element is too fast to be read by a user. For example, as illustrated in FIG. 6, the quality control software causes the object to travel from the top of the screen and decelerate until stop in the middle of the screen, where the application awaits user input to continue the test. Upon indication from the user (such as clicking a button provided for this purpose by the application), the object 610 accelerates thru the bottom of the screen (the X axis). The quality control application of the present invention is configured to assess whether the object has behaved as intended.

To assess the behavior of the object 610, first an edge detection algorithm is applied record the relative position of the object through its journey down the screen. Corresponding datapoints for the object are recorded as it moves, which include the coordinates on the graph (pixel points x₁,y₁ to xₙ,yₙ), associated time stamps for each coordinate, and other information such as expected pixel density, screen resolution, and physical screen size. Using this object datapoints and screen information, the application can calculate the speed and acceleration perceived by an end user viewing a screen of specific size and resolution (for example, the application may calculate that a 55 in, 4K screen yields an acceleration of 2 cm/s² for a certain object made to move at a certain speed) In some embodiments, motions of multiple objects can be measured. In some embodiments, the testing application may be configured to use edge detection and pattern recognition to identify the performance of transient objects as they appear and leave the screen.

In general, it should be understood that embodiments apply to systems, methods, and computer readable medium.

Inventions are described herein and are claimed by way of explicit and implicit disclosure as would be understood by those of ordinary skill in the art.

The application may be implemented on a system, server, computing device, or computer. A system, server, computing device, and computer can be implemented on one or more computer systems and be configured to communicate over a network.

The computer system also includes a main memory, such as a random access memory (RAM) or other dynamic storage device, coupled to bus for storing information and instructions to be executed by a processor of one or more computers of the computer system Main memory also may be used for storing temporary variables or other intermediate information during execution of instructions to be executed by a processor. Such instructions, when stored in non-transitory storage media accessible to processor, configure the computer system into a special-purpose machine that is customized to perform the operations specified in the instructions and provide or be capable of features and functionality described herein.

The computer system further includes a read only memory (ROM) or other static storage device coupled to bus for storing static information and instructions for processor. A storage device, such as a magnetic disk or optical disk, is provided and coupled to bus for storing information and instructions.

The computer system may be coupled via bus to a display, such as an LCD, for displaying information to a computer user. An input device, including alphanumeric and other keys, may be coupled to bus for communicating information and command selections to processor. Another type of user input device is cursor control, such as a mouse, a trackball, touchscreen (e.g., on mobile phones) or cursor direction keys for communicating direction information and command selections to processor and for controlling cursor movement on display. This input device typically has two degrees of freedom in two axes, a first axis (e.g., x) and a second axis (e.g., y), that allows the device to specify positions in a plane.

The computer system may implement the techniques described herein using customized hard-wired logic, one or more ASICs or FPGAs, firmware and/or program logic which in combination with the computer system causes or programs computer system to provide specialized features. According to one embodiment, the techniques herein are performed by the computer system in response to the processor executing one or more sequences of one or more instructions contained in main memory. Such instructions may be read into main memory from another storage medium, such as storage device. Execution of the sequences of instructions contained in main memory causes the processor to perform the process steps described herein. In alternative embodiments, hard-wired circuitry may be used in place of or in combination with software instructions.

The term storage media as used herein refers to any non-transitory media that stores data and/or instructions that cause a machine to operation in a specific fashion. Such storage media may comprise non-volatile media and/or volatile media. Non-volatile media includes, for example, optical or magnetic disks, such as storage device. Volatile media includes dynamic memory, such as main memory. Common forms of storage media include, for example, hard disk, solid state drive, or any other magnetic data storage medium, a CD-ROM, any other optical data storage medium, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus. Transmission media can also take the form of acoustic or light waves, such as those generated during radio-wave and infra-red data communications.

Various forms of media may be involved in carrying one or more sequences of one or more instructions to the processor for execution. For example, the instructions may initially be carried on a magnetic disk or solid state drive of a remote computer. A hardware bus carries the data to main memory, from which processor retrieves and executes the instructions. The instructions received by main memory may optionally be stored on storage device either before or after execution by the processor.

The computer system also includes a communication interface coupled to bus. The communication interface provides a two-way data communication coupling to a network link that is connected to a local network. For example, the communication interface may be an integrated services digital network (ISDN) card, cable modem, satellite modem, or a modem to provide a data communication connection to a corresponding type of telephone line. As another example, the communication interface may be a local area network (LAN) card to provide a data communication connection to a compatible LAN. Wireless links may also be implemented. In any such implementation, the communication interface sends and receives electrical, electromagnetic or optical signals that carry digital data streams representing various types of information.

Network link typically provides data communication through one or more networks to other data devices. For instance, network link may provide a connection through local network to a host computer or to data equipment operated by an Internet Service Provider (ISP). ISP in turn provides data communication services through the worldwide packet data communication network now commonly referred to as the “Internet.” Local network and Internet both use electrical, electromagnetic or optical signals that carry digital data streams. The signals through the various networks and the signals on network link and through the communication interface, which carry the digital data to and from the computer system, are example forms of transmission media.

Hardware and software implementation is also illustratively described or understood from the attached Visual QA document and the incorporated patent application applications mentioned above.

The computer system can send messages and receive data, including program code, through the network(s), network link and the communication interface. In the Internet example, a server might transmit a requested code for an application program through Internet, ISP, local network and the communication interface.

The received code may be executed by the processor as it is received, and/or stored in storage device, or other non-volatile storage for later execution.

It should be understood that variations, clarifications, or modifications are contemplated Applications of the technology to other fields are also contemplated.

Exemplary systems, devices, components, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention.

Thus, for example, any sequence(s) and/or temporal order of steps of various processes of methods that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It is also implicit and understood that the applications or systems illustratively described herein provide computer-implemented functionality that automatically performs a process or process steps. This can involve human-software interaction such as if desired by selecting images or selecting controls for the process that automatically carried out.

It is understood from the above description that the functionality and features of the systems, devices, components, or methods of embodiments of the present invention include generating and sending signals to accomplish the actions.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention.

It should be understood that combinations of described features or steps are contemplated even if they are not described directly together or not in the same context.

The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology. This includes an understanding of implicit features that for example may involve multiple possibilities, but to a person of ordinary skill in the art a reasonable or primary understanding or meaning is understood.

It should be understood that the above-described examples are merely illustrative of some of the many specific examples that represent the principles described herein. Clearly, those skilled in the art can readily devise numerous other arrangements without departing from the scope of the present invention.

What is claimed is:

1. A quality assurance system for visual software development, comprising:
a computer using computer readable software instructions stored in a non-transient memory;
a quality assurance application implemented on the computer using the computer readable software instructions, and wherein the computer readable software instructions configure the computer to identify discrepancies between a design image of a user interface for an application and a screenshot of the user interface as displayed by the application, wherein the quality assurance application is further configured using the computer readable software instructions to perform computer-implemented steps comprising:
performing a first comparison between the design image and the screenshot to identify one or more discrepancies between the design image and the screenshot;
excluding from the discrepancies those corresponding to visual elements on the screenshot that include dynamic content, the excluding comprising:
identifying which of the discrepancies are structural discrepancies;
applying a mask to every visual element corresponding to a structural discrepancy on both the design image and the screenshot resulting in one or more masked visual elements in the design image and one more masked visual elements in the screenshot, wherein the mask is shaped like the visual element;
performing a second comparison between the design image and screenshot, wherein a lack of discrepancies detected by the second comparison between a masked visual element on the design image and a corresponding masked visual element on the screenshot indicates that the masked visual elements on the screenshot includes dynamic content; and
generating an image of the screenshot, wherein the generated image of the screenshot includes a visual indication of every discrepancy detected by the second comparison as the identified discrepancies between the design image and the screenshot.

2. The system of claim 1, wherein the steps further comprise generating and displaying a discrepancy map showing areas of discrepancy between the design image and the screenshot as shaded areas.

3. The system of claim 1, wherein performing the first or the second comparison comprises traversing the design image and the screenshot using a Structural Similarity Index analysis on every pixel.

4. The system of claim 1, wherein the one or more discrepancies comprise color patches, missing elements, and structural discrepancies.

5. The system of claim 1, wherein each of color patches, missing elements, and structural discrepancies is identified based on different combinations of local luminance similarity, local contrast similarity, and local structure similarity.

6. The system of claim 1, wherein applying the mask comprises applying a contrast-based mask than applies a shadow to regions of the visual element corresponding to the structural discrepancy where contrast is higher than a small value.

7. The system of claim 1, further comprising generating a bug report that includes an inventory of the identified discrepancies, their location, and measures of the divergence of their corresponding visual elements from the design image.

8. A computer-implemented method for identifying discrepancies between a design image of a user interface for an application and a screenshot of the user interface as displayed by the application, the method comprising:
performing a first comparison between the design image and the screenshot to identify one or more discrepancies between the design image and the screenshot;
excluding from the discrepancies those corresponding to visual elements on the screenshot that include dynamic content, the excluding comprising:
identifying which of the discrepancies are structural discrepancies;
applying a mask to every visual element corresponding to a structural discrepancy on both the design image and the screenshot resulting in one or more masked visual elements in the design image and one more masked visual elements in the screenshot, wherein the mask is shaped like the visual element;
performing a second comparison between the design image and screenshot, wherein a lack of discrepancies detected by the second comparison between a masked visual element on the design image and a corresponding masked visual element on the screenshot indicates that the visual elements on the screenshot includes dynamic content; and
generating an image of the screenshot, wherein the generated image of the screenshot includes a visual indication of every discrepancy detected by the second comparison as the identified discrepancies between the design image and the screenshot.

9. The method of claim 8, further comprising generating and displaying a discrepancy map showing areas of discrepancy between the design image and the screenshot as shaded areas.

10. The method of claim 8, wherein performing the first or the second comparison comprises traversing the design image and the screenshot using a Structural Similarity Index analysis on every pixel.

11. The method of claim 8, wherein the one or more discrepancies comprise color patches, missing elements, and structural discrepancies.

12. The method of claim 11, wherein each of color patches, missing elements, and structural discrepancies is identified based on different combinations of local luminance similarity, local contrast similarity, and local structure similarity.

13. The method of claim 8, wherein applying the mask comprises applying a contrast-based mask than applies a shadow to regions of the visual element corresponding to the structural discrepancy where contrast is higher than a small value.

14. The method of claim 8, further comprising generating a bug report that includes an inventory of the identified discrepancies, their location, and measures of the divergence of their corresponding visual elements from the design image.
